(19) United States
(12) Patent Application Publication
(10) Pub. No.: US 2009/0208838 A1
(43) Pub. Date: Aug. 20, 2009

(54) ELECTRODE ASSEMBLY AND SECONDARY BATTERY HAVING THE SAME

(75) Inventor: Jinhee Kim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI, Co., Ltd., Suwon-si (KR)

(21) Appl. No.: 12/356,264

(22) Filed: Jan. 20, 2009

(30) Foreign Application Priority Data
Feb. 19, 2008 (KR) 10-2008-0014826

(51) Int. Cl. H01M 2/02; H01M 4/60; H01M 4/62

(52) U.S. Cl. 429/163; 429/212; 429/217

(57) ABSTRACT

An electrode assembly and a secondary battery having the same that can prevent an electrode coating portion from being separated from an electrode collector and generation of cracks on a surface of the ceramic layer coated on the electrode, the secondary battery comprising: an electrode assembly; a can having an upper opening to receive the electrode assembly; and a cap assembly covering the opening of the can, wherein the electrode assembly comprises a positive electrode plate, a negative electrode plate, and ceramic layers that are coated on at the surfaces of the positive electrode plate and the negative electrode plate that face each other, and the ceramic layers include a ceramic powder, a binder, and an additive, and the additive comprises at least one of vinyl acetate, maleic acid, and maleate.

### CROSS REFERENCE TO RELATED APPLICATION

This application is based on and claims priority to Korean Patent Application No. 10-2008-0014826, filed on Feb. 19, 2008 in the Korean Intellectual Property Office (KIPO), the entire contents of which are hereby incorporated by reference.

### BACKGROUND

1. Technical Field

The present disclosure relates to an electrode assembly and a secondary battery having the same, and more particularly, to an electrode assembly comprising an electrode plate comprising flexible ceramic layers, and a secondary battery having the same.

2. Description of the Related Art

Generally, a secondary battery can be reused repeatedly by recharging, and thus, differs from a disposable battery, which can be used only once. Secondary batteries are generally used as main power supplies for portable communication devices, information processing devices, and audio/video devices. Recently, a great deal of interest has been focused on secondary batteries, which exhibit at least one of ultra-light weight, high energy density, high output voltage, a low self-discharge rate, environmental friendliness, and a long lifetime as a power supply, resulting in rapid developments.

Secondary batteries are divided into nickel-hydrogen or nickel-metal hydride (Ni-MH) batteries, and lithium ion (Li-ion) batteries according to the electrode active material. Particularly, lithium ion secondary battery can be further divided according to the type of electrolyte into liquid electrolyte, solid polymer electrolyte, and a gel phase electrolyte types. In addition, lithium ion secondary batteries may also be divided according to the shape of the container receiving the electrode assembly, for example, into is divided into square type, cylindrical type, pouch type, etc.

Lithium ion secondary batteries can be made into ultra-lightweight batteries because the energy density-per-weight is much higher than a disposable battery. Average voltages per a cell of lithium ion secondary batteries compared with other types of secondary batteries such as a NiCad battery or a nickel-hydrogen battery are 3.6V and 1.2 V, respectively. Thus, lithium ion secondary batteries are three times more compact than other types of secondary batteries. In addition, the self-discharging rate of a lithium ion secondary battery is less than about 5% a month at 20° C., which corresponds to about ⅓ of self-discharging rate of a NiCad battery or a nickel-hydrogen battery. Lithium ion secondary batteries are environmentally-friendly because they do not use heavy metals such as cadmium (Cd) or mercury (Hg), and are also advantageously rechargeable more than about 1,000 times under a conditions. Thus, lithium ion secondary batteries have been developed rapidly for use in information and communication technology devices due to the above advantages.

A typical secondary battery bare cell is manufactured by disposing an electrode assembly including a positive electrode plate, a negative electrode plate, and a separator in a can comprising aluminum or aluminum alloy, covering an upper opening of the can with a cap assembly, injecting an electrolyte into the can, and sealing the can.

The separator is typically a polyolefin film separator that prevents an electrical short circuit between the positive electrode and the negative electrode plates. In addition, the separator itself functions as a safety device that prevents overheating of the battery. However, the separator may be damaged if the battery temperature continuously increases for a certain time, even though micro-holes in the separator close when the battery temperature is suddenly increased for any reason, for example, by external heat transfer.

Additionally, the battery temperature does not decrease when the current is shutdown, the heat continuously melting the separator even though micro-holes of the separator are closed when large current flows in the secondary battery in a short time due to a high capacity of the battery. Thus, the possibility of an electrical short caused by damage of the separator is increased. In addition, when the separator is deformed by vibration and/or impact, or is improperly wound in the manufacture of the battery, the separator might not perform the function of separating the positive electrode from the negative electrode plates. Accordingly, failure rate of products may be increased and production stability may be degraded.

To solve the thermal problem of the film separator, there has been proposed a method of improving safety in case of internal short circuiting comprising disposing ceramic layers on an electrode plate by coating a paste comprising ceramic powder, a binder, and a solvent on the electrode.

However, if stress is applied to the ceramic layer during drying of the ceramic paste after coating, an electrode coating portion of the electrode plate, that is, an active material coating layer that is wetted by solvent from the ceramic paste, is pulled off of the electrode plate by force caused by the stress. Accordingly, the resulting adhesion between the electrode collector and the electrode coating portion after coating with the ceramic layers is weaker than the adhesion before coating. The resulting separation or loosening of the electrode coating portion from the electrode collector, for example, over repeated charge/discharge cycles of the battery and/or after injection of the electrolyte therein can increase the resistance of the battery.

In addition, cracks may be generated at the surface of the ceramic layers the ceramic-coated electrode plates are wound because the ceramic layers become hard after heat-drying.

### SUMMARY OF THE INVENTION

An object is to provide an electrode assembly and a secondary battery having the same that can prevent an electrode coating portion from being separated from an electrode collector when a ceramic layer is coated on the electrode, and prevent generation of cracks on a surface of the ceramic layer coated on the electrode.

Some embodiments provide an electrode assembly and a secondary battery comprising the same. The electrode assembly comprises a positive electrode plate, a negative electrode plate, and at least one ceramic layer disposed between the positive electrode plate and the negative electrode plate. In some embodiments, surfaces of the positive electrode plate and the negative electrode plate facing each other comprise a ceramic layer. The ceramic layer comprises a ceramic powder, a binder, and an additive that improves at least one of the flexibility and porosity of the ceramic layer. Embodiments of the secondary battery comprising the electrode assembly exhibit one or more of improved resistance to catastrophic failure from physical or thermal damage, and improved durability and reliability.

Additional advantages, objects and features will be set forth in part in the description which follows, and in part will become apparent to those having ordinary skill in the art upon examination and/or practice thereof.

According to one aspect, there is provided an electrode assembly, which includes: a positive electrode plate; a negative electrode plate; and ceramic layers, coated on at least the surfaces of the positive electrode plate and the negative electrode plate that face to each other, including ceramic powder, a binder, and an additive, wherein the additive includes at least one compound selected from the group consisting of vinyl acetate, maleic acid, and maleate.

The additive is added to improve flexibility of the ceramic layers. A content of the additive may be from about 5 wt % to about 10 wt % with respect to the amount of the binder.

The binder forms a copolymer with the additive through a copolymerization reaction. The binder may comprise an acrylate type rubber, and more particularly, at least one compound selected from the group consisting of polymers and copolymers of ethyl acrylate, methyl acrylate, buthyl acrylate, hexyl acrylate, and ethyl hexyl acrylate.

The positive electrode plate and the negative electrode plate may each include an electrode coating portion.

The electrode coating portion of the positive electrode plate and/or the negative electrode plate coated with the ceramic layers may include styrene butadiene rubber (SBR) as the binder and carboxyl methyl cellulose (CMC) as a thickener.

The ceramic layers may be formed by coating ceramic paste made by mixing the binder, additive, and solvent with the ceramic powder on the positive electrode plate or the negative electrode plate.

The ceramic powder of the ceramic layers may have a purity of more than about 99.999%.

In addition, the ceramic powder may comprise at least one compound selected from the group consisting of alumina, silica, zirconia, zeolite, magnesia, titanium oxide, and barium titanate.

According to another aspect, there is provided a secondary battery, which includes: an electrode assembly having the above described construction; a can having an upper opening to receive the electrode assembly; and a cap assembly covering the opening of the can.

Some embodiments provide an electrode assembly and a secondary battery comprising the same, the electrode assembly, comprising: a positive electrode plate; a negative electrode plate, a surface of the negative electrode plate facing a surface of the positive electrode plate; and a ceramic layer, disposed on at least each of the surfaces of the positive electrode plate and negative electrode plate facing each other, wherein each ceramic layer comprises a ceramic powder, a binder, and an additive, wherein the additive comprises at least one of vinyl acetate, maleic acid, and maleate.

In some embodiments, the additive is within a range of from about 5 wt % to about 10 wt % of the binder.

In some embodiments, the binder comprises an acrylate rubber. In some embodiments, the binder comprises at least one of polymers and copolymers of ethyl acrylate, methyl acrylate, butyl acrylate, hexyl acrylate, and ethyl hexyl acrylate.

In some embodiments, the positive electrode plate and the negative electrode plate each comprises an electrode coating portion over which the ceramic layer is disposed, and each electrode coating portion comprises styrene butadiene rubber (SBR) and carboxyl methyl cellulose (CMC).

In some embodiments, the ceramic layer comprises a dried ceramic paste comprising a mixture of the binder, the additive, a solvent, and the ceramic powder.

In some embodiments, the ceramic powder comprises at least one of alumina, silica, zirconia, zeolite, magnesia, titanium oxide, and barium titanate. In some embodiments, the additive comprises butyl maleate or ethyl maleate.

In some embodiments, the secondary battery further comprises: a can comprising an upper opening configured to receive the electrode assembly; and a cap assembly covering the upper opening of the can, wherein the electrode assembly is disposed in the can.

### BRIEF DESCRIPTION OF THE DRAWINGS

The above and other objects, features and advantages will be more apparent from the following detailed description taken in conjunction with the accompanying drawings, in which:

FIG. 1 is an exploded perspective view illustrating a secondary battery according to one exemplary embodiment;

FIG. 2 is a magnified view illustrating ‘A’ region of FIG. 1; and

FIG. 3 is a graph illustrating an extension length versus load in a strain-stress test.

### DETAILED DESCRIPTION OF CERTAIN EMBODIMENTS

Hereinafter, preferred embodiments will be described in detail with reference to the accompanying drawing. The aspects and features, and methods for achieving the aspects and features will be apparent by referring to the embodiments to be described in detail with reference to the accompanying drawings. However, the present disclosure is not limited to the embodiments disclosed hereinafter, but can be implemented in diverse forms. The matters defined in the description, such as the detailed construction and elements, are specific details provided to assist those of ordinary skill in the art in a comprehensive understanding thereof, which is defined by the scope of the appended claims. In the entire description, the same drawing reference numerals are used for the same or similar elements across various figures.

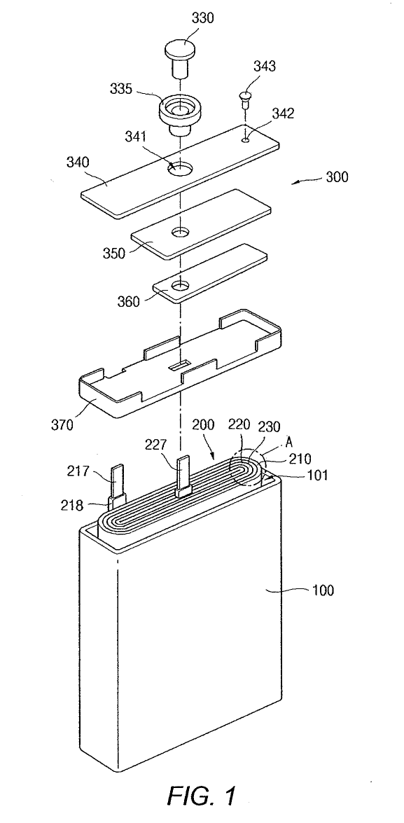

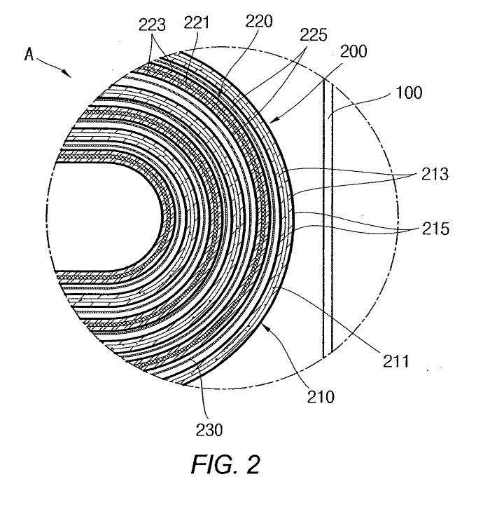

FIG. 1 shows an exploded perspective view illustrating a secondary battery according to one exemplary embodiment, and FIG. 2 shows a magnified view illustrating ‘A’ region of FIG. 1.

Referring to FIGS. 1 and 2, the secondary battery includes a can 100, an electrode assembly 200 received in the can, and a cap assembly 300 sealing an opening of the can. The electrode assembly 200 includes flexible ceramic layers 215 and 225. A square type secondary battery is shown in the drawing, but is not limited thereto.

The can 100 may be made of metal having a roughly rectangular parallelepiped shape, but is not limited thereto. The can 100 can itself function as a terminal. The can 100 includes an upper opening 101 through which the electrode assembly 200 is received.

The cap assembly 300 includes an electrode terminal 330, a cap plate 340, an insulation plate 350, and a terminal plate 360. The cap assembly 300 engages the upper opening 101 of the can 100, and is insulated from the electrode assembly 200 by a separate insulation case 370, thereby sealing the can 100.

The electrode terminal 330 is electrically connected to a positive electrode tab 217 of a positive electrode plate 210 or a negative electrode tab 227 of a negative electrode plate 220, which functions as a positive electrode terminal or a negative electrode terminal, respectively.

The cap plate 340 comprises a metal plate having a size and shape corresponding to the upper opening 101 of the can 100. A terminal hole 341 of a predetermined size is disposed in the middle of the cap plate 340. The electrode terminal 330 is inserted into the terminal hole 341. When the electrode terminal 330 is inserted into the terminal hole 341, a tube type gasket 335 engaging an outer surface of the electrode terminal 330 is inserted together with the electrode terminal, thereby insulating the electrode terminal 330 from the cap plate 340. An electrolyte injection hole 342 of a predetermined size is disposed at one side of the cap plate 340, and a safety vent (not shown) may be disposed at the other side. The safety vent is formed integrally with the cap plate 340 by reducing the thickness of a surface of the cap plate 340. After the cap assembly 300 is secured to the upper opening 101 of the can 100, the electrolyte is injected into the can through the electrolyte injection hole 342. Then, the electrolyte injection hole 342 is sealed with a stopper 343.

The electrode assembly 200 may include a positive electrode plate 210, a negative electrode plate 220, and ceramic layers 215 coated on at least the surfaces of the positive electrode plate and the negative electrode plate that face to each other. The electrode assembly 200 is wound in a jelly-roll fashion. In addition, the secondary battery may further include a separator 230 that is interposed between the positive electrode plate 210 and negative electrode plate 220, and wound theretogether as shown in the drawing. However, other embodiments do not comprise a separator 230.

The positive electrode plate 210 includes a positive electrode collector 211 comprising aluminum foil and a positive electrode coating portion 213 comprising lithium oxide as a main component coated on both surfaces of the positive electrode collector 211. Positive electrode non-coating portions (not illustrated) are disposed at both ends of the positive electrode collector 211, wherein the positive electrode non-coating portions comprise regions on one or both surfaces of the positive electrode collector 211 on which the positive electrode coating portion 213 is not disposed. A positive electrode tab 217 is provided on the positive electrode non-coating portion (not shown). An insulation tape 218 is wound on a portion of the positive electrode tab 217 extending from the electrode assembly 200 to prevent an electrical short.

The negative electrode plate 220 includes a negative electrode collector 221 comprising thin copper foil and a negative electrode coating portion 223 comprising a carbon material as a main component coated on both surfaces of the negative electrode collector 221. Negative electrode non-coating portions (not illustrated) are disposed at both ends of the negative electrode collector 221, where the negative electrode non-coating portion are regions on one or both surfaces of the negative electrode collector 221 on which the negative electrode coating portion 223 is not disposed. A negative electrode tab 227 is provided on the negative electrode non-coating portion (not shown). An insulation tape 218 is wound on a portion of the negative electrode tab 227 extending from the electrode assembly 200 to prevent an electrical short.

In some embodiments, the positive electrode coating portion and negative electrode coating portion 213 and 223 may be coated with a thickener such as carboxyl methyl cellulose (CMC) and then adhered to the electrode collectors 211 and 221 using a binder such as styrene butadiene rubber (SBR), but not limited thereto.

The ceramic layers 215 and 225 comprise a ceramic paste made by mixing the binder, additive, and solvent with the ceramic powder, and coating the resulting mixture on at least the of surfaces of the positive electrode plate and the negative electrode plate that face to each other.

For example, in the jelly-roll type electrode assembly formed by stacking and winding two electrodes, the ceramic layers 215 and 225 may be formed on at least the surfaces of the positive electrode plate and negative electrode plate that face to each other by (i) forming the ceramic layers on the respective outer surfaces of the two electrodes, or (ii) forming the ceramic layers on the respective inner surfaces of the two electrodes, or (iii) forming the ceramic layers on both the inner and outer surfaces of any one of the two electrodes.

Referring to FIG. 2, as an example of method (iii) as described above, the ceramic layers 215 and 225 are formed on both of the inner and outer surfaces of both the positive electrode plate 210 and negative electrode plate 220, but not limited thereto.

The ceramic layers 215 and 225 function as a film separator 230 comprising, for example, PP (polypropylene) and/or PE (polyethylene). Here, the ceramic powder of the ceramic layers 215 and 225 comprises at least one material selected from the group consisting of alumina, silica, zirconia, zeolite, magnesia, titanium oxide, and barium titanate, for example, with a purity of more than about 99.999%. Decomposition temperatures of the materials are higher than about 1,000° C. Thus, thermal stability of the secondary battery comprising the ceramic layers is prominently improved.

In addition, a film separator of polyolefin type 230 contracts and/or melts at temperatures of greater than about 100° C. However, the ceramic layers 215 and 225 have excellent heat resistance. Thus, the ceramic layers 215 and 225 do not contract and/or melt even at temperatures over about 100° C., for example, when an internal short occurs in the secondary battery.

In other words, in the case of the film separator of polyolefin type 230 comprising PP or PE, in addition to the initial damage caused by the heat generated by the internal short, a peripheral region of the separator 230 subsequently contracts and/or melts. Thus, the damaged portion of the film separator 230 becomes larger, thereby increasing the severity of the short. However, in embodiments in which the electrodes 210 and 220 comprise the ceramic layers 215 and 225, even if an internal short is generated, a small portion of the ceramic layers 215 and 225 is damaged around the short, but a peripheral region of the ceramic layers 215 and 225 near the short does not contract and/or melt. Thus, the internal short portion does not expand.

In addition, the secondary battery comprising a ceramic powder of high porosity has a high charge/discharge rate. The electrolyte injection speed is also improved because the ceramic layers 215 and 225 quickly absorb the electrolytic solution. Thus, productivity of the secondary battery can be improved. In addition, repeated charge/discharge cycles decompose and exhaust the electrolyte between the electrode plates. The ceramic layers 215 and 225 high absorption absorb the electrolyte around it and supply the electrolyte to the electrode. Thus, durability of the battery is improved.

Here, the ceramic layers 215 and 225 may function as the film type separator 230 comprising PP or PE. However, the film separator of polyolefin type 230 and the ceramic layers 215 and 225 may be used together to improve safety. Or, as described above, a battery may comprise only the ceramic layers 215 and 225 instead of the film separator of polyolefin type 230.

On the other hand, the solvent in the ceramic paste may include at least one compound selected from a group consisting of NMP (N-methylpyrrolidone), cyclohexanone, water, toluene, and xylene. The solvent acts as dispersing medium for the ceramic powder, binder and, additive, and is substantially totally evaporated in drying process thereafter. Thus, the final ceramic layers 215 and 225 comprise the ceramic powder and binder.

The ceramic layers 215 and 225 are thermally stable with a melting point of greater than about 1,000° C. as described above. In addition, the ceramic powder with a purity of greater than about 99.999% has high chemical resistance, and thus does not react with the electrolyte of the lithium ion secondary battery. The ceramic powder is greater than about 90 wt % of the total amount of the ceramic powder and binder. Accordingly, the physical properties of the binder are important to improve safety and reliability of the ceramic layers. The binder comprises an organic material containing carbon, and may comprise an acrylate rubber, and more particularly, at least one compound selected from the group consisting of polymers and copolymers of ethyl acrylate, methyl acrylate, butyl acrylate, hexyl acrylate, and ethyl hexyl acrylate.

The binder should have high heat resistance in order to enable the ceramic layers 215 and 225 to function as a good separation barrier for preventing a short between the positive electrode coating portion 213 and negative electrode coating portion 223 at high temperatures. In addition, the binder should have strong adhesion in order to bond the ceramic powder particles to each other, as well as to the electrodes on the positive electrode coating portion 213 and the negative electrode coating portion 223. In addition, the chemical resistance to the organic electrolyte in the secondary battery, oxidation resistance, and reduction resistance in the nominal voltage range of the battery are also desirable.

When the adhesion between the electrode collectors 211 and 221 and the positive electrode coating portion 213 and the negative electrode coating portion 223 is very weak, the positive electrode coating portion and/or the negative electrode coating portion 213 and 223 may separate from the electrode collectors 211 and 221 by stress, for example, created by the ceramic layers 215 and 225 hardening at the time of drying and wetting of the electrode coating portions 213 and 223 by the solvent of the ceramic paste. Accordingly, in the electrode assembly, the additive is added to the binder in the ceramic paste, thereby increasing the viscosity of the ceramic paste and supporting the positive electrode coating portion 213 and the negative electrode coating portion 223, as well as preventing the ceramic layers 215 and 225 from hardening after drying. The additive may include at least one compound selected from the group consisting of vinyl acetate, maleic acid, and maleate.

When styrene butadiene rubber (SBR) is used in the binder for adhering the positive electrode coating portion 213 and the negative electrode coating portion 223 to the electrode collectors and carboxyl methyl cellulose (CMC) is used in the thickener, the adhesion between the positive electrode coating portion 213 and the negative electrode coating portion 223 and electrode collectors may be weak. In some embodiments, the additive is added to the ceramic paste to provide flexibility to the binder by forming copolymers with the binder. Thus, such flexibility can prevent cracks from forming in the ceramic layers 215 and 225 after hardening, as well as drying of the positive electrode coating portion 213 and the negative electrode coating portion 223. In addition, the additive improves the adhesion between the electrode coating portion and electrode collector. Thus, increased resistance of the secondary battery arising from loosening and/or separation of the electrode coating portion from the electrode collector is reduced or prevented.

The additive is within the range of about 5 wt % to about 10 wt % to the weight of the binder. In some embodiments with less than about 5 wt % of the additive, the binder is insufficiently flexible to form flexible ceramic layers 215 and 225. In some embodiments with greater than 10 wt % of the additive, the proportions of the binder and ceramic powder are relatively reduced, and thus adhesion of the ceramic layers 215 and 225 and electrolyte absorption capacity are decreased.

As described above, in a secondary battery according to the embodiment, the flexible ceramic layers 215 and 225 are formed on the electrodes 210 and 220, with collectors 211 and 221 comprising a positive electrode coating portion 213 and a negative electrode coating portion 223 coated with a paste comprising a ceramic powder, a binder containing a mechanically, thermally, and electrochemically stable additive, and solvent. Thus, safety properties such as short-circuit resistance and heat resistance at normal and high temperatures, durability, and reliability of the secondary battery are improved.

Physical properties of the ceramic layers will be explained in more detail according to experimental examples provided below, but not limited thereto.

### EXPERIMENTAL EXAMPLE 1

Experimental Example 1 provides measurements of the dependence of the viscosity of ceramic paste according to the binder and additive of the ceramic layer; strain-stress after coating ceramic layer; degree of swelling after coating ceramic layer; and 180° peel strength after disassembly. The proportion of binder to ceramic in the ceramic paste was 5:95 by weight.

### Viscosity of the Ceramic Paste

The viscosity of the ceramic paste was measured at 50 rpm using a #62 spindle using a DV-2+PRO viscometer (Brookfield Company, USA).

### Strain-Stress After Ceramic Layer Coating

The ceramic layer was coated on a negative electrode plate using SBR as the binder and the coated electrode cut into 2.5 cm wide and 5 cm long samples. Then, strain-stress and extension length were measured using a strain-stress measuring device. The load range was 50.99 kgf, and the speed was 50 mm/min. For convenience, Table 1 indicates the force needed to extend each sample by 0.7 cm.

### Degree of Swelling After Ceramic Layer Coating

An electrode plate coated with a ceramic layer was cut into a 5 cm×5 cm sample, which were immersed in an electrolyte for three days. Then, the percentage weight increase is provided in Table 1

### Peel Strength After Disassembly

A secondary battery was manufactured by using an electrode plate coated with a ceramic layer and subjected to one charge/discharge cycle. Then, the battery was disassembled in the discharged state, and the electrode plate cleaned with DMC and dried. Then, 180° peel strength of the electrode plate was measured. Results for each example and comparison example are provided in Table 1.

TABLE 1

| | | Additive | Viscosity | Strain-stress | Swelling | 180° peel strength |
|---|---|---|---|---|---|---|
| | Binder | (wt %) | (cps) | (kgf) | (%) | (gf/mm) |
| Comp. Ex. 1 | ethyl acrylate | — | 90 | 3.8 | 140 | 0.25 |
| Comp. Ex. 2 | methyl acrylate | — | 75 | 2.7 | 135 | 0.10 |
| Comp. Ex. 3 | butyl acrylate | — | 80 | 2.5 | 130 | 0.15 |
| Comp. Ex. 4 | hexyl acrylate | — | 70 | 3.9 | 120 | 0.30 |
| Comp. Ex. 5 | 2-ethylhexyl | — | 60 | 3.2 | 125 | 0.45 |
| | acrylate | | | | | |
| Comp. Ex. 6 | butyl acrylate | vinyl acetate | 100 | 2.7 | 132 | 0.2 |
| | | 3 wt % | | | | |
| Comp. Ex. 7 | butyl acrylate | maleic acid | 90 | 3.0 | 134 | 0.3 |
| | | 3 wt % | | | | |
| Comp. Ex. 8 | butyl acrylate | butyl maleate | 105 | 3.3 | 135 | 0.5 |
| | | 3 wt % | | | | |
| Example 1 | ethyl acrylate | vinyl acetate | 300 | 5.2 | 150 | 0.5 |
| | | 5 wt % | | | | |
| Example 2 | ethyl acrylate | maleic acid | 500 | 5.1 | 170 | 2.5 |
| | | 5 wt % | | | | |
| Example 3 | ethyl acrylate | butyl maleate | 400 | 5.3 | 200 | 5.0 |
| | | 5 wt % | | | | |
| Example 4 | methyl acrylate | vinyl acetate | 200 | 5.4 | 160 | 3.0 |
| | | 7 wt % | | | | |
| Example 5 | methyl acrylate | maleic acid | 150 | 6.1 | 180 | 4.2 |
| | | 7 wt % | | | | |
| Example 6 | methyl acrylate | butyl maleate | 250 | 4.9 | 190 | 1.6 |
| | | 7 wt % | | | | |
| Example 7 | butyl acrylate | vinyl acetate | 330 | 4.8 | 180 | 2.3 |
| | | 10 wt % | | | | |
| Example 8 | butyl acrylate | maleic acid | 400 | 5.6 | 200 | 4.3 |
| | | 10 wt % | | | | |
| Example 9 | butyl acrylate | butyl maleate | 600 | 6.2 | 210 | 3.5 |
| | | 10 wt % | | | | |
| Example 10 | hexyl acrylate | vinyl acetate | 700 | 4.8 | 165 | 2.7 |
| | | 5 wt % | | | | |
| Example 11 | hexyl acrylate | maleic acid | 680 | 5.0 | 170 | 3.8 |
| | | 5 wt % | | | | |
| Example 12 | hexyl acrylate | butyl maleate | 460 | 5.3 | 175 | 4.6 |
| | | 5 wt % | | | | |
| Example 13 | 2-ethylhexyl | vinyl acetate | 550 | 5.4 | 180 | 2.8 |
| | acrylate | 10 wt % | | | | |
| Example 14 | 2-ethylhexyl | maleic acid | 850 | 5.9 | 170 | 2.5 |
| | acrylate | 10 wt % | | | | |
| Example 15 | 2-ethylhexyl | butyl maleate | 670 | 6.3 | 200 | 5.0 |
| | acrylate | 10 wt % | | | | |

In the Comparison Examples 1 to 5, the negative electrode plates used SBR as the binder, and were manufactured and coated with the ceramic paste after measuring the viscosity of the ceramic paste comprising alumina, alkyl acrylate binder, and NMP solvent. In the comparison examples 6 to 8, a small amount of the additive was added to the negative electrode plate to improve flexibility.

In the Examples 1 to 15, the negative electrode plates used SBR as the binder, and were manufactured and coated with ceramic paste after measuring the viscosity of the ceramic paste comprising alumina, alkyl acrylate binder, additive for improving flexibility, and NMP solvent.

From the viscosity measurement results of the ceramic paste, it was confirmed that the viscosity increased when the ceramic paste comprised a flexible binder that was a copolymer comprising vinyl acetate, maleic acid, or maleate and an alkyl acrylate. Accordingly, the viscosities of the comparison examples 6 to 8 were higher than the viscosities of the Comparison Examples 1 to 5. Particularly, the viscosities were higher in the Examples 1 to 15 in which the additive was in greater than 5 wt % relative to the amount of the binder. If the viscosity of the ceramic paste is increased as described above, the ceramic paste protects the electrode coating portion having otherwise poor adhesion. Thus, separation of the active material from the collector is prevented or reduced.

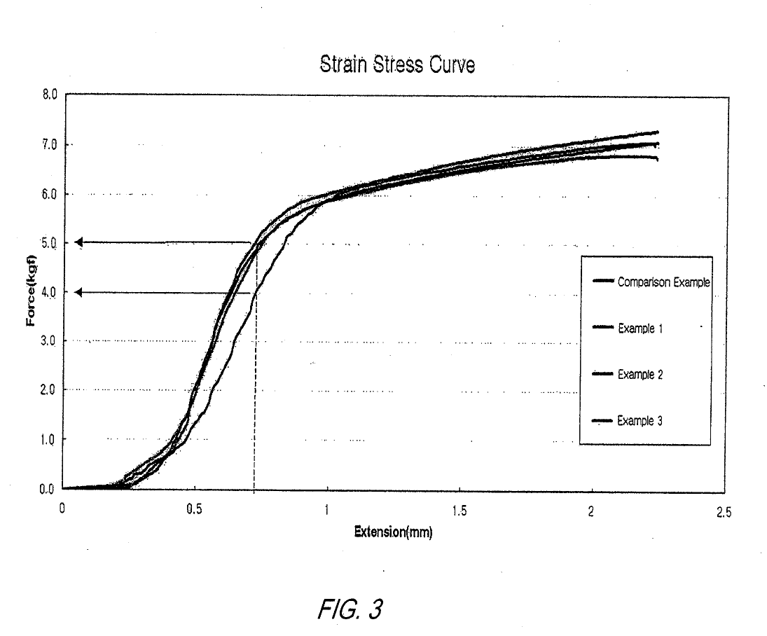

FIG. 3 is a graph illustrating extension length of an electrode with a ceramic layer coating versus load in the strain-stress test. The extension length is a length that copper foil in the active material extends until it is broken, and thus depends on an extension rate of the copper foil. Accordingly, the extension length has a similar value regardless of addition of any additive to improve flexibility of the ceramic layer. However, the strain-stress is the force applied to extend to a given length. Accordingly, in the Examples 1 to 15, the strain-stresses of the electrode plate coated with the ceramic layer were higher than the strain-stresses of the Comparison Examples 1 to 8 because the additive improved flexibility. In other words, a stronger force was needed to extend or break the electrode plate including the flexible ceramic layer. This result means that it is more difficult to break the electrode plate having the flexible ceramic layer. In addition, the result also means that the electrode plate having the flexible ceramic layer is safer with respect to mechanical safety such as nail-passing therethrough and/or under compression.

With respect to the degree of swelling after ceramic layer coating, swelling in Examples 1 to 15 was significantly improved compared with Comparison Examples 1 to 8. In Examples 1 to 15, durability of the battery was improved because the electrolyte could be supplied into the electrode plate more smoothly, and the insulating property of the ceramic layer is maintained for a longer time because the flexible additive absorbed the electrolyte and the swelling sealed any fine cracks generated in the ceramic layer.

With respect to the peel strength after disassembling, as shown in Table 1, the peel strengths of the electrode plates coated with the ceramic layer in Examples 1 to 15 were higher than the peel strengths in Comparison Examples 1 to 8. Thus, degradation of adhesion strength between the electrode coating portion and electrode collector and/or separation of the electrode coating portion after the ceramic layer coating were significantly improved by improved flexibility of the binder due to the additive.

### EXPERIMENTAL EXAMPLE 2

Experimental Example 2 compared flexibility, nail-passing penetration, 150° C. oven test, and durability of electrodes comprising embodiments of ceramic layers and secondary batteries comprising the same with comparative examples. Results are provided in Table 2. The proportion of binder to ceramic in the ceramic paste was 5:95 by weight. The amount of additive was relative to the amount of binder in wt %.

### Flexibility of the Ceramic Layer

A 20 μm thick ceramic layer was coated on a negative electrode plate using SBR as the binder and the layer dried. Then, the plate was wound on a 3-mm diameter rod and generation of any cracks was observed by electron microscopy. In Table 2 below, samples with cracks are indicated as “NG” and samples without cracks are indicated as “OK.”

### Nail-Passing Penetration

In the Examples and Comparison Examples, thirty secondary battery samples were manufactured and were overcharged by 120% and a nail completely driven through each sample. Each sample was observed for fire and/or explosion. In Table 2 below, cases without change are indicated as “OK” and cases of fire/explosion are indicated as “NG.”

### 150° C. Oven Test

In the Examples and Comparison Examples, thirty secondary battery samples were charged to 100% and then put in an oven. The temperature of the oven was raised at 5° C./min until the temperature reached 150° C. The samples were kept at 150° C. for 1 hour. The samples were observed for fire and/or explosion. In Table 2 below, cases without change are indicated as “OK” and cases of fire/explosion are indicated as “NG.”

### Durability

The secondary battery samples were charged to 1 C/4.2V and discharged to 1 C/3V. Capacity retention ratios were calculated as ratios (%) of a discharging capacity of the 300th cycle relative to a discharging capacity of the first discharge. In Table 2, cases with a capacity retention ratio of less than 90% are indicated as “NG”, and cases with a capacity retention ratio more than 90% are indicated as “OK”.

TABLE 2

| | | Additive | | | | |
|---|---|---|---|---|---|---|
| | Binder | (wt %) | Flexibility | Nail penetration | 150° oven | Durability |
| Comp. Ex. 1 | ethyl acrylate | — | NG | NG | NG | NG |
| Comp. Ex. 2 | methyl acrylate | — | NG | NG | NG | NG |
| Comp. Ex. 3 | butyl acrylate | — | NG | NG | NG | NG |
| Comp. Ex. 4 | hexyl acrylate | — | NG | NG | NG | NG |
| Comp. Ex. 5 | ethyl hexyl | — | NG | NG | NG | NG |
| | acrylate | | | | | |
| Comp. Ex. 6 | butyl acrylate | vinyl acetate | NG | NG | NG | NG |
| | | 3 wt % | | | | |
| Comp. Ex. 7 | butyl acrylate | maleic acid | NG | NG | NG | NG |
| | | 3 wt % | | | | |
| Comp. Ex. 8 | butyl acrylate | maleate | NG | NG | NG | NG |
| | | 3 wt % | | | | |
| Example 1 | ethyl acrylate | vinyl acetate | OK | OK | OK | OK |
| | | 5 wt % | | | | |
| Example 2 | ethyl acrylate | maleic acid | OK | OK | OK | OK |
| | | 5 wt % | | | | |
| Example 3 | ethyl acrylate | maleate | OK | OK | OK | OK |
| | | 5 wt % | | | | |
| Example 4 | methyl acrylate | vinyl acetate | OK | OK | OK | OK |
| | | 7 wt % | | | | |
| Example 5 | methyl acrylate | maleic acid | OK | OK | OK | OK |
| | | 7 wt % | | | | |
| Example 6 | methyl acrylate | maleate | OK | OK | OK | OK |
| | | 7 wt % | | | | |
| Example 7 | butyl acrylate | vinyl acetate | OK | OK | OK | OK |
| | | 10 wt % | | | | |
| Example 8 | butyl acrylate | maleic acid | OK | OK | OK | OK |
| | | 10 wt % | | | | |
| Example 9 | butyl acrylate | maleate | OK | OK | OK | OK |
| | | 10 wt % | | | | |
| Example 10 | hexyl acrylate | vinyl acetate | OK | OK | OK | OK |
| | | 5 wt % | | | | |
| Example 11 | hexyl acrylate | maleic acid | OK | OK | OK | OK |
| | | 5 wt % | | | | |
| Example 12 | hexyl acrylate | maleate | OK | OK | OK | OK |
| | | 5 wt % | | | | |
| Example 13 | ethyl hexyl | vinyl acetate | OK | OK | OK | OK |
| | acrylate | 10 wt % | | | | |
| Example 14 | ethyl hexyl | maleic acid | OK | OK | OK | OK |
| | acrylate | 10 wt % | | | | |
| Example 15 | ethyl hexyl | maleate | OK | OK | OK | OK |
| | acrylate | 10 wt % | | | | |

Referring to Table 2, in the Examples 1 to 15, with the improved flexibility of the ceramic layers, cracks on the electrodes were not observed even where ceramic layers were coated on the electrode plates with weak adhesion to the active material, in contrast with the Comparison Examples 1 to 8.

Accordingly, safety in the nail-penetration test and thermal stability at 150° C. were also greatly improved. In addition, reliability and durability of the secondary battery were improved because cracks were not generated in the ceramic layer.

As described above, an electrode assembly and secondary battery having the same produce the following effects.

First, the electrode coating portion resists separation from the electrode collector even if the electrode coating portion is adhered to the electrode collector by a binder with weak adhesion because the additive added to the binder improves flexibility of both the binder and the ceramic layer.

Second, the electrode coating portion resists separation from the electrode collector, thereby preventing an increase in resistance of the secondary battery caused by a loosened electrode coating portion.

Third, the ceramic layer is flexible, thereby preventing generation of cracks on the surface of the ceramic layer.

Fourth, a ceramic layer with excellent heat resistance is coated on the electrode, thereby improving thermal stability against internal short circuits.

It should be understood by those of ordinary skill in the art that various replacements, modifications, and changes in the form and details may be made therein without departing from the spirit and scope of the present disclosure as defined by the following claims. Therefore, it is to be appreciated that the above described embodiments are for purposes of illustration only and are not to be construed as limitations.

What is claimed is:

1. An electrode assembly, comprising:
a positive electrode plate;
a negative electrode plate, a surface of the negative electrode plate facing a surface of the positive electrode plate; and
a ceramic layer, disposed on at least each of the surfaces of the positive electrode plate and negative electrode plate facing each other, wherein each ceramic layer comprises a ceramic powder, a binder, and an additive,
wherein the additive comprises at least one of vinyl acetate, maleic acid, and maleate.

2. The electrode assembly of claim 1, wherein the additive is within a range of from about 5 wt % to about 10 wt % of the binder.

3. The electrode assembly of claim 1, wherein the binder comprises an acrylate rubber.

4. The electrode assembly of claim 3, wherein the binder comprises at least one of polymers and copolymers of ethyl acrylate, methyl acrylate, butyl acrylate, hexyl acrylate, and ethyl hexyl acrylate.

5. The electrode assembly of claim 1, wherein the positive electrode plate and the negative electrode plate each comprises an electrode coating portion over which the ceramic layer is disposed, and each electrode coating portion comprises styrene butadiene rubber (SBR) and carboxyl methyl cellulose (CMC).

6. The electrode assembly of claim 1, wherein the ceramic layer comprises a dried ceramic paste comprising a mixture of the binder, the additive, a solvent, and the ceramic powder.

7. The electrode assembly of claim 1, wherein the ceramic powder comprises at least one of alumina, silica, zirconia, zeolite, magnesia, titanium oxide, and barium titanate.

8. The electrode assembly of claim 1, wherein additive comprises butyl maleate or ethyl maleate.

9. A secondary battery, comprising:
the electrode assembly of claim 1;
a can comprising an upper opening configured to receive the electrode assembly; and
a cap assembly covering the upper opening of the can,
wherein the electrode assembly is disposed in the can.

10. The secondary battery of claim 9, wherein the additive is within a range of from about 5 wt % to about 10 wt % of the binder.

11. The secondary battery of claim 9, wherein the binder comprises an acrylate rubber.

12. The secondary battery of claim 11, wherein the binder comprises at least one of polymers and copolymers of ethyl acrylate, methyl acrylate, butyl acrylate, hexyl acrylate, and ethyl hexyl acrylate.

13. The secondary battery of claim 9, wherein the positive electrode plate and negative electrode each plate comprises an electrode coating portion over which the ceramic layer is disposed, and each electrode coating portion comprises styrene butadiene rubber (SBR) and carboxyl methyl cellulose (CMC).

14. The secondary battery of claim 9, wherein the ceramic layer comprises a dried ceramic paste comprising a mixture of the binder, the additive, a solvent, and the ceramic powder.

15. The secondary battery of claim 9, wherein the ceramic powder comprises at least one of alumina, silica, zirconia, zeolite, magnesia, titanium oxide, and barium titanate.

16. The secondary battery of claim 9, wherein the additive comprises either butyl maleate or ethyl maleate.
